(19) United States
(12) Patent Application Publication
(10) Pub. No.: US 2018/0014075 A1
(43) Pub. Date: Jan. 11, 2018

(54) MEDIA PLAYBACK DEVICE AND SYSTEM

(71) Applicant: MAGIC MEDIA WORKS LIMITED, London (GB)

(72) Inventors: Rob LEWIS, London (GB); Farhan SYED, London (GB)

(21) Appl. No.: 15/539,306

(22) PCT Filed: Dec. 24, 2015
(86) PCT No.: PCT/GB2015/054165

§ 371 Date: Jun. 23, 2017

(30) Foreign Application Priority Data
Dec. 24, 2014 (GB) 1423202.9
Oct. 14, 2015 (GB) 1518184.5

(51) Int. Cl. H04N 21/482; H04N 21/41; H04N 21/4363; H04N 21/61

(52) U.S. Cl. CPC H04N 21/482; H04N 21/6125; H04N 21/4126; H04N 21/43635

(57) ABSTRACT

A media playback system is configured to automatically establish a connection, via a wireless network, to an internet-based media platform, delivering copyright-protected media assets and establishing access to some or all of those assets. No prior user configuration, set-up, sign-up or other user identification for that media delivery platform is needed because the system automatically and uniquely identifying itself to the media delivery platform to enable that platform, or an access control component associated with the platform, to determine if the system is licensed to receive streaming media, irrespective of the user of the system. The system can include a portable remote control device that enables a user to select copyright-protected media, such as streaming media, from the media delivery platform. The remote control is used to control a user interface displayed on a TV that has been re-purposed to serve as the streaming media output.

### BACKGROUND OF THE INVENTION

### 1. Field of the Invention

This invention relates to a media playback device and system configured to automatically establish a connection, via a wireless network, to an internet-based media platform delivering copyright-protected media assets and to enable those media assets to be played and/or displayed to an end-user. One specific application is a media playback device that enables easy enjoyment of internet-based music streaming services with millions or tens of millions of music tracks.

### 2. Discussion of Related Art

Streaming music is the fastest growing sector in the music industry, but as of 2014 there were only 30 million paying subscribers globally, whereas 200 million people used to regularly buy CDs. So 85% of the addressable market of people who in the past have been willing to spend money on music have not converted to any subscription or paid-for streaming music service, despite the theoretical advantages of having unlimited access to discover and play millions or tens of millions of different music tracks.

This is because current subscription based systems are too technically complex for many people to feel comfortable with, especially if they have been used to much simpler forms of music enjoyment, such as just turning a radio on or buying a CD and popping it into a CD player and pressing ‘play’. The complexity of having to download a music streaming app, complete an account sign-up process for that app, chose passwords, enter configuration information for the hardware and commit to recurring subscriptions is too great a dis-incentive for many people, especially when compared with the simplicity of earlier devices, like record players and CD players. That complexity is compounded by the need, if you want some form of home-based system, as opposed to simply playing back music from your smartphone, to purchase dedicated hardware systems like Sonos home audio system.

These dedicated home audio systems provide excellent audio performance, but are too complex for many ordinary users to set-up. And when the system fails, a common experience is to simply stop using it altogether because working out what has gone wrong and re-setting it all it is too daunting for many ordinary users.

As a consequence, despite the vast quantity of music now available on line, and the high quality of streaming music, the paradox is that entirely passive music listening modes, such as listening to broadcast radio, have become the norm for many people who in the past would have been active purchasers of vinyl or CDs and enjoyed a personalized, but also highly social or communal music listening experience.

Also, current streaming music services are optimised for a single-user experience—e.g. an app that is downloaded to a user's smartphone, allowing the user to listen to music on the go via headphones or a wireless connected speaker. These apps are predominantly appealing to people in the under 35 years demographic - for whom downloading an app and buying a subscription online is not so daunting and for whom headphone listening is an established habit. A group listening experience is possible with say a Bluetooth enabled loudspeaker connected to the smartphone, but it is not readily possible to share the experience of selecting an album or track, since the music list is displayed solely on one person's smartphone. So entirely lacking is the possibility of a genuinely shared experience of both listening to music and collaboratively choosing the music to listen to: when music was delivered on physical media, like vinyl or CDs, played on a sound system, this was not only possible but central to the social aspects of music listening. Much of that social richness has been lost with current modes of smartphone-centric music listening.

The aim of this invention is to create a media playback system that eliminates these technical complexities and therefore gives a music or media entertainment experience that is effortless, fun & engaging, and enables social or group-based selection of music tracks combined with social or group-based listening to those tracks.

This invention therefore addresses a specific problem arising in one form of conventional Internet-based media consumption services. The problem is that the ordinary user is faced with needing to download a music streaming app to their smartphone or tablet, complete an account sign-up process for that app, chose passwords so that the app can control the software and, finally, commit to recurring subscriptions. For relatively tech-savvy consumers, this is all routine, but there are a great many people for whom this is too complex, especially when compared with what they are use to, which is buying vinyl or a CD, and the very simple process of playing that vinyl or CD. The technical problem of setting-up or configuring a system is even greater where some form of dedicated home audio system is used.

The challenge we address is to provide the technical architecture that enables the replication of the simplicity and social aspects of the pre-Internet music or media experience, yet provides an easy to set-up, inherently social media playback system that also gives the extensive and immediate access to, and easy search of, tens of millions of tracks that is only possible with an Internet-based service.

### SUMMARY OF THE INVENTION

A first aspect of the invention is a media playback system configured to automatically establish, a connection, via a wireless network, to an internet-based music platform delivering copyright-protected media assets and establishing access to some or all of those assets but without requiring (for example, in normal operation) any prior user configuration, set-up, sign-up or other user identification for that media delivery platform;

the system automatically and uniquely identifying itself to the media delivery platform to enable that platform, or an access control component associated with the platform, to determine if the system is licensed to receive streaming media, irrespective of the user of the system.

The system appeals to people who love music but who have yet to adopt app-based streaming music services with their complex set-up of accounts and their subscription based models; typically, this demographic likes tangible physical products that offer simple and fast set-up.

Optional features include the following:

The system may include a portable remote control device that enables a user to select copyright-protected media, such as streaming music, from the media delivery platform.

The system may re-purpose an existing media or sound reproduction system, such as a TV, hi-fi system or speakers, and use that as its streaming media output source. The remote control can, where an existing TV is used as the media output source, be used to control a user interface displayed on the TV that enables an end-user to search for, select and playback media. The system may then include a unit that plugs into the HDMI port of the TV and that generates the user-interface and receives and processes control inputs from the remote control and sends data requesting media to the media delivery platform and receives that data and presents it via the HDMI interface to the TV for playback.

The system may, instead of re-purposing an existing media or sound reproduction system, include a self-contained device including a speaker, a power source, a user interface (such as a touch screen UI) and Wi-Fi or other LAN connectivity that enables a user to select copyright-protected media, such as streaming music, from the media delivery platform.

The system, whether it includes a re-purposed TV or the self-contained device described above, may generate and present a user interface with a home screen that includes three icons for ‘My Music’, ‘Discover’ and ‘Search’ or equivalent functionality.

In this implementation, the user interface includes a first level UI which is a skeuomorphic representation of physical recording media, such as CDs, vinyl, album covers etc. The skeuomorphic representation of physical media are arranged in an array and the user can scroll or navigate through the array. When a user selects a particular CD or vinyl to play, then the representation of the CD or vinyl will start to spin around in a skeuomorphic representation; this may be in a second level down in the UX hierarchy. The ‘Discover’ mode when selected causes a skeuomorphic representation of physical recording media, such as CDs, vinyl to be displayed, each associated with a different curator or genre or channel or other source. The ‘Search’ mode when selected causes an on-screen keyboard to be shown, together with a microphone icon; selecting the microphone icon activates a voice recognition system, allowing the user to simply speak the name of the artist, album genre, curator etc.

When a specific artist is chosen, then a skeuomorphic representation of physical recording media, such as CDs, vinyl, album covers of that artist is shown in an array that the user can readily scroll or navigate through.

The user interface has three primary levels of depth for simplicity and ease of user comprehension: (1) the home screen, with the three key functions of ‘My Music’, ‘Discover’ and ‘Search’ or equivalent functionality; (2) the array of CDs or vinyl associated with the function selected at the home screen level: (3) a screen showing the currently playing album or track.

User tagging of content is possible, e.g. hashtags. User defined collections of one or more of the following: artists, albums and tracks, radio stations and pod casts, are formed as searchable objects and are accessible through the ‘My Music’ option.

The system can be implemented in various different form factors; one implementation we describe in detail later in this specification is the variant with a HDMI stick that plugs into the HDMI socket of a conventional TV to re-purpose that TV as a streaming music player. Another variant we describe in more detail is the self-contained device with its own speaker and touch screen and Wi-Fi capability. Other variants are also possible, such as in-car systems.

Also, it would be possible for the user-purchasable device to be just an HDMI stick on its own; when plugged into a TV or laptop or tablet or smartphone, or any other type of electronic unit, it would provide streaming of fully licensed media assets and provide the user interface that the user operates in the manner normal for the device the stick is plugged into.

Further, although we specifically reference the HDMI standard, the invention is equally applicable to any audio or video or audio/video interface.

A second aspect is a method of enabling a media playback system configured to automatically establish a connection, via a wireless network, to an internet-based media platform delivering copyright-protected media assets and establishing access to some or all of those assets but without requiring in normal operation any prior user configuration, set-up, sign-up or other user identification for that media delivery platform;

(i) the method including the step of the system automatically and uniquely identifying itself to the media delivery platform with a unique identifier;

(ii) the platform, or an access control component associated with the platform, determining, using the unique identifier, if the system is licensed to receive streaming media, irrespective of the user of the system;

(iii) if the system is licensed, then providing access to search and stream some or all of the media assets.

A third aspect is a remote control device for a music playback system, in which the remote control device includes a microphone and is voice-controlled, so that a user can select a specific music track or genre by speaking its name to the remote control device to initiate streaming from an internet-based music delivery platform and the system also transmits sounds received at the microphone to an audio playback device, such as a TV, for the speakers in or connected playback device to reproduce, to enable a ‘karaoke’ mode.

The system can re-purpose an existing media or sound reproduction system, such as a TV, hi-fi system or speakers, and uses that as its streaming media output source.

Multiple pairing is possible—i.e. to pair several remote controls with the same media or sound reproduction system so that several people can join in the karaoke session, each using their own paired, remote control as a microphone.

A fourth aspect is a method of controlling functions in an application that enables music tracks to be streamed from a database of music tracks from an internet-based music delivery platform, in which menu items are displayed on a screen, and in which:

a music track or album is graphically represented on the screen as a CD or vinyl single or album that spins whilst it is playing.

If search results have multiple different albums, or whenever you need to show multiple albums, then the screen graphically depicts a stack of CDs or vinyl singles or albums.

Menu items may be selected using a remote control with motion or gesture detection, or may be selected from menu items shown on a touch screen.

The method may be implemented using a system that includes a portable remote control device that enables a user to select copyright-protected media, such as streaming music, from the media delivery platform and the screen is the screen of a TV that is controlled by the remote control. The system re-purposes an existing media or sound reproduction system, such as a TV, hi-fi system or speakers, and uses that as its streaming media output source.

The method may be implemented using a system that includes a self-contained device including a speaker, a power source, a user interface with a touch screen UI and Wi-Fi or other TAN connectivity that enables a user to select copyright-protected media, such as streaming music, from the media delivery platform; and the CD or vinyl is shown on the touch screen of the self-contained device.

Appendix 1 lists all of the key features of the system.

### BRIEF DESCRIPTION OF THE FIGURES

An implementation of the invention will be described with reference to the following FIGS.:

FIG. 1 is a view of two key elements in the system, namely the remote control unit and a HDMI stick that plugs into the HDMI port of the TV;

FIG. 2-12 are views of various different designs of the remote control unit;

FIG. 13 are views of the HDMI stick;

FIG. 14 is a screenshot of the home screen of the user interface;

FIGS. 15 and 16 are a screenshot of the screen at the 1^{st} level of the menu hierarchy; this shows the user's personal playlist, arranged as an array or vinyl or CDs;

FIG. 17 is a screenshot showing what happens when the ‘info’ icon is selected for a specific album, with information on the various tracks of the selected album being listed;

FIG. 18 is a screenshot showing that when a specific album or track is playing, the associated CD or vinyl is shown spinning around, together with self-explanatory control icons;

FIG. 19 is a view of a second implementation of the invention as a self-contained small, speaker system with an Android embedded SOC and a touch sensitive screen, that will allow users to access a streaming music service via an Android app/Web Interface embedded in the system.

### DETAILED DESCRIPTION

The invention is implemented in two different variants, one that re-purposes an existing domestic TV or audio system and one that uses a device with a dedicated touch screen and speaker.

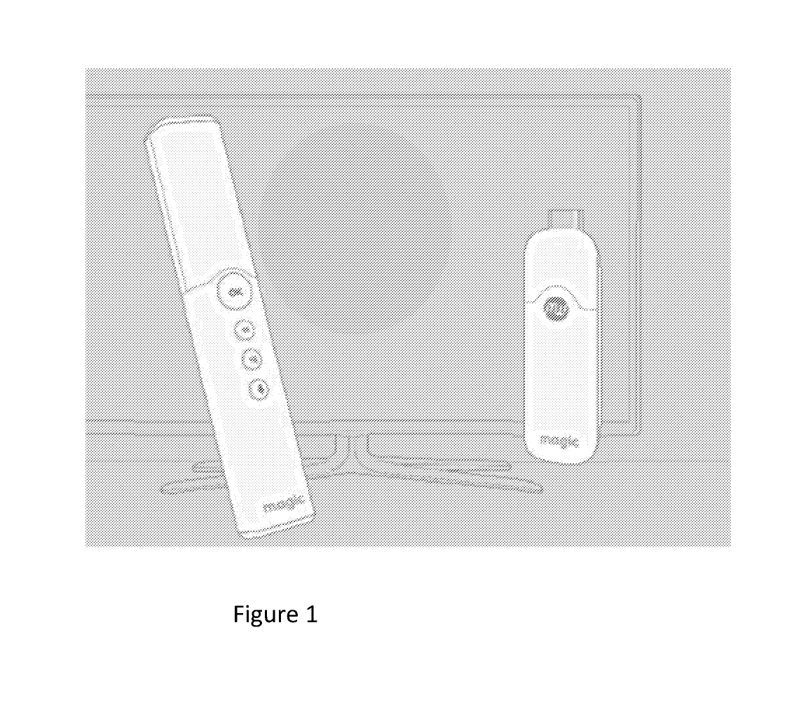

The first variant includes a remote controller and an HDMI ‘stick’ or ‘dongle’, with the HDMI stick re-purposing an existing media or sound reproduction system—for example with the stick being inserted into the HDMI port of a conventional TV, as suggested in FIG. 1, or being connected to a conventional domestic sound system or speakers using a line out connection. The HDMI stick has a form factor similar to other HDMI sticks, like the Intel Compute Stick.

The HDMI stick jumps onto the local domestic Wi-Fi and opens a connection to a remote web-based media asset service or platform; it feeds the media signals (e.g. streaming audio or video) received from the remote web-based media asset service or platform to the re-purposed sound system,—e.g. the TV over the HDMI link for the TV to pass through its speakers and display and hence generates the UX that is shown on the TV display.

The handheld remote controller controls the UX shown on the TV display, enabling a user to navigate through the music library, and select genres, tracks, stations etc. using gesture base control of an on-screen cursor, and also through voice control (e.g. the user can say ‘Play The Rolling Stones’ into a microphone in the handheld remote controller and then that is processed (either locally at the remote control, or the HDMI stick, or remotely at the web-based media asset service or platform, or some combination of any of those), resulting in the web-based media asset service or platform serving up streaming audio or video of The Rolling Stones, received by the HDMI stick over the local Wi-Fi and then fed into the TV or other re-purposed device via the HDMI port and hence played back over the TV set or other device.

Key features of this system are:
The user simply plugs in the stick to any ordinary HDMI enabled TV, registers with a local Wi-Fi network and then is able to immediately search for music tracks using a user interface displayed on the TV and is also able to immediately play them through the TV speakers. There is no need to subscribe to any service, or enter credit card details. The remote control is gesture, voice and touch controlled and allows the user to select icons and navigate the user interface displayed on the TV.
Consumers will be streaming music within sixty seconds of unboxing.
Twelve months of advertisement-free music listening is provided with every device. Music rights owners are in effect paid a lump sum for each device kit sold to an end-user (the device kit includes the remote controller, HDMI stick and power adaptor), instead of the more conventional approach of them being paid per stream. The sum paid to them is sufficient to enable the device kit to in effect allow unlimited, licensed streaming for 12 months. Once the 12 months expires, then the user can purchase an additional 12 months ad-free subscription or opt to listen to occasional advertisements. The system or remote server stores the date of first use of the system or its access to the media delivery platform and permits continued access to search and stream some or all of the media assets for a predefined time period, such as 12 months. Another variant is to sell the device kit at a higher price and provide lifetime unlimited streaming.
Families can enjoy listening together again. Because the large display screen of the TV shows the music search screen with highly engaging graphics, and what is playing at any one time, again with highly engaging graphics, and the TV is anyway at the heart of shared audio-visual experiences in the home, the system enables music search, discovery and listening to once more become a shared, communal experience, much as it was in the heyday of vinyl.

We will now look at the detailed requirements for the controller, HDMI stick and the client application.

### The Controller or Remote Control

The Controller is a simple four button controller optimised for intuitive interactions with the music service. The gesture-based controller, similar to a Nintendo Wii, controls the user interface on the TV, and includes a microphone for voice-searching of the music catalogues. Key electronic components are:

BOSCH BMIO55 Accelerometer and Gyroscope

2.4 Ghz factory-pairing to TV stick.

900 MAh rechargeable battery

Rechargeable via Micro USB, 5Y, 0.5A

TED with multiple flash patterns

Haptic feedback to communicate physical cues from the UI

Key features include the following:

The controller must provide the freedom to be anywhere in the room to allow wireless interaction with the interface.

The controller must provide a natural and intuitive interaction method.

The controller must provide data from voice input to activate and issue commands.

The controller must have a method for confirming actions.

The controller must provide data for acceleration, velocity, tracking movement, position and orientation in 2D and 3D space (6 degrees of freedom: translation in x, y, z and rotation in x, y, z).

The controller must provide data for recognising gestures (tap, swipe, pan, etc.).

The controller must reset its coordinate space (zero) after it becomes idle or inactive.

The controller must automatically activate the TV input source (HDMI Consumer Electronics Control).

The controller must be pre-paired to the stick and if required, be easily re-paired.

The controller has a dedicated ‘back’ button to go back through the UI, a dedicated ‘action’ button to play a song and select an item in the UI, a dedicated ‘pause-resume’ button that pauses or resumes playback of the current playing track, a dedicated ‘voice’ button that activates the microphone and displays the ‘voice search’ UI, as well as voice commands and karaoke mode activation.

The controller must have a portable power source to sufficiently power the components, which must be easily replaced or recharged.

The controller must have an TED as a feedback mechanism to report its state.

The controller could provide haptic feedback (vibration) whose pattern, strength and duration is programmable.

The controller must have a robust and durable charge point cable connector. The controller must act as a microphone for karaoke

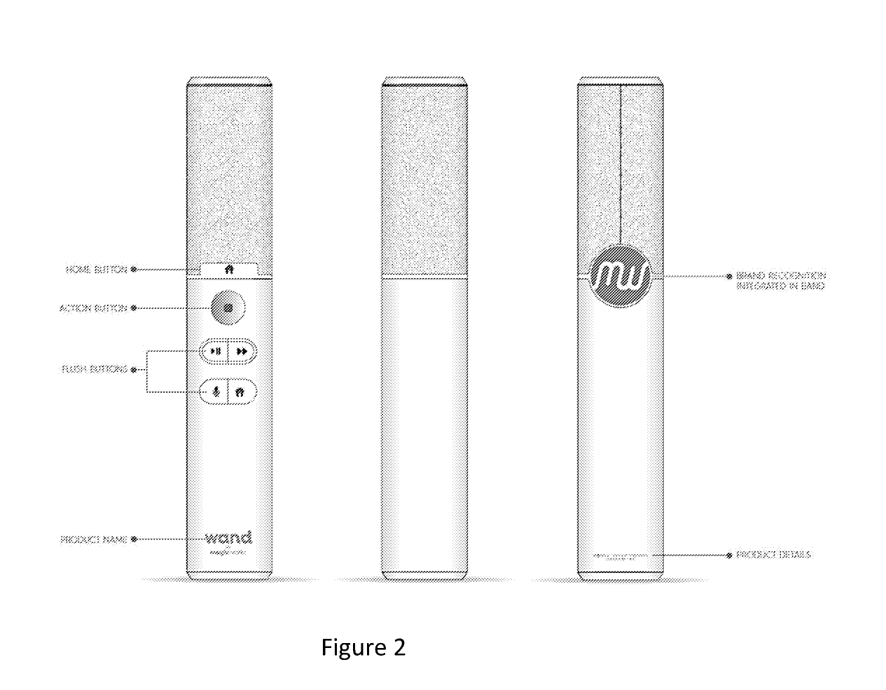

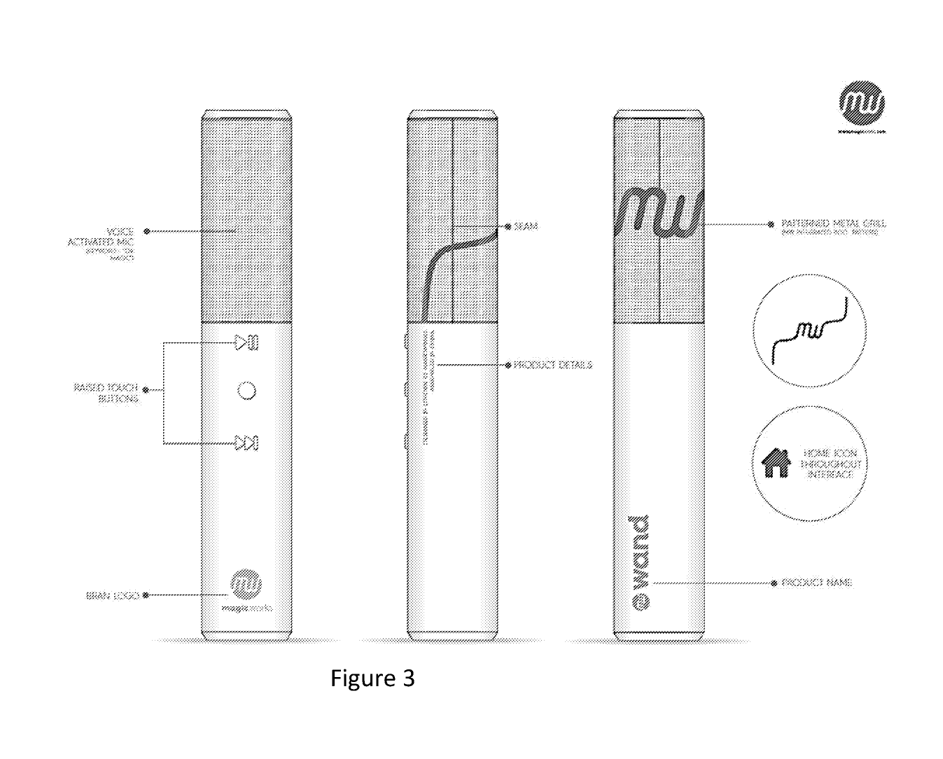

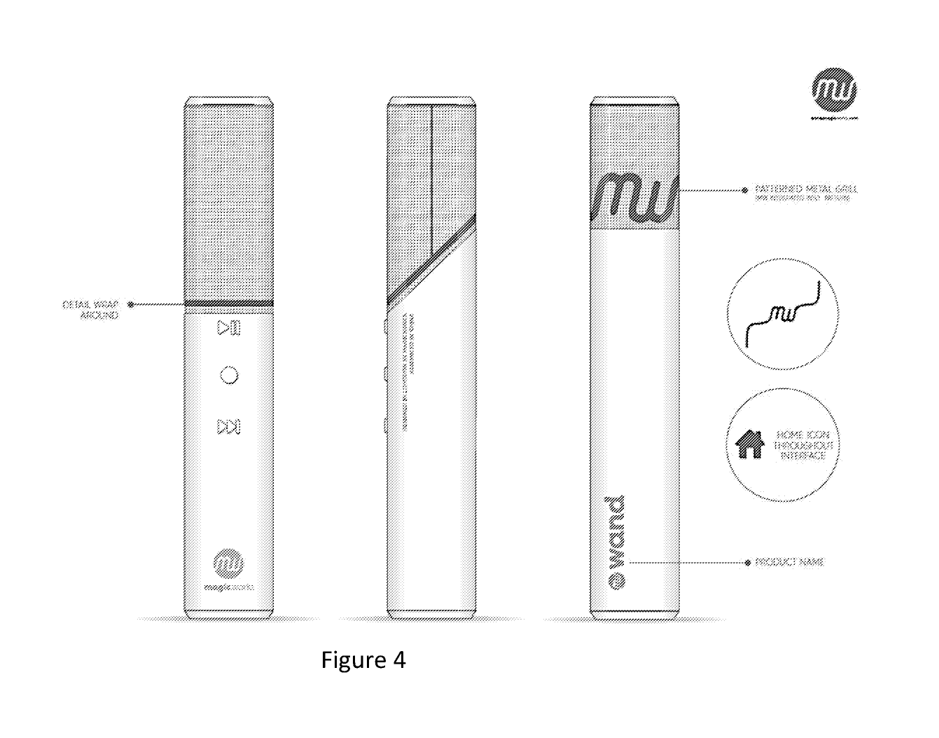

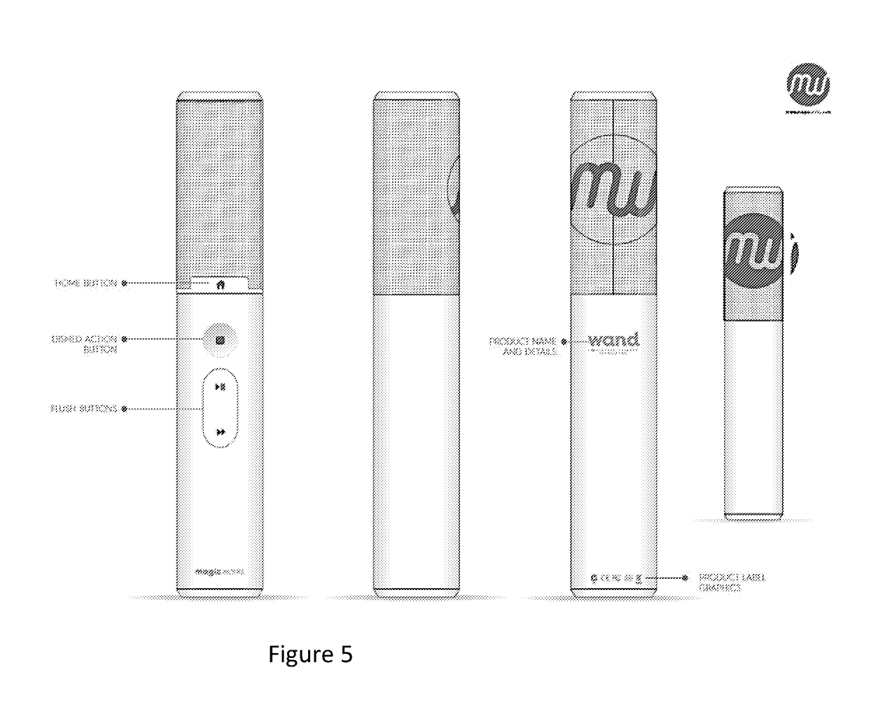

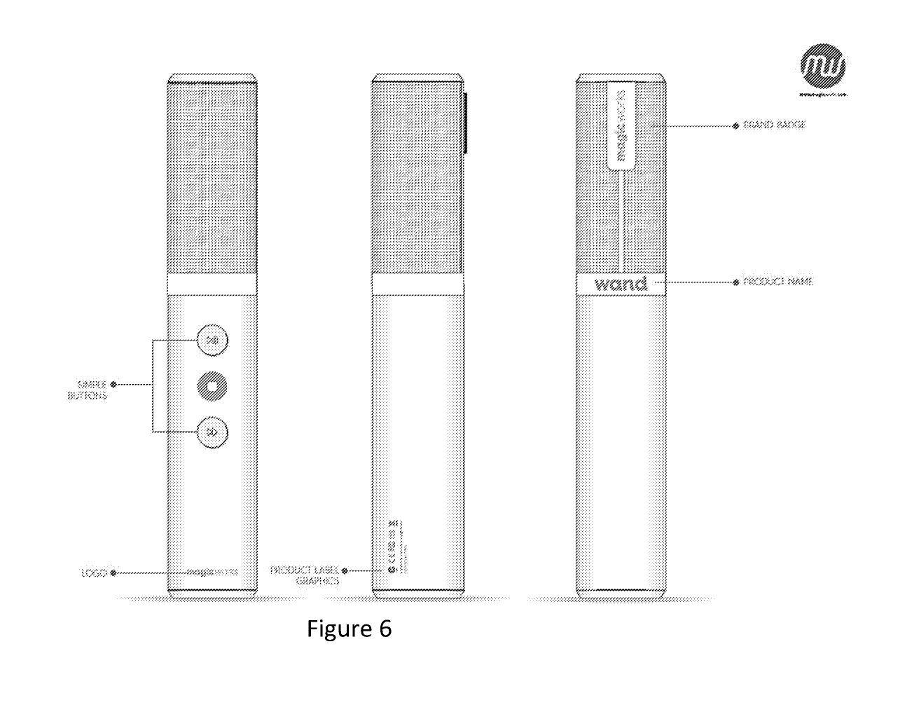

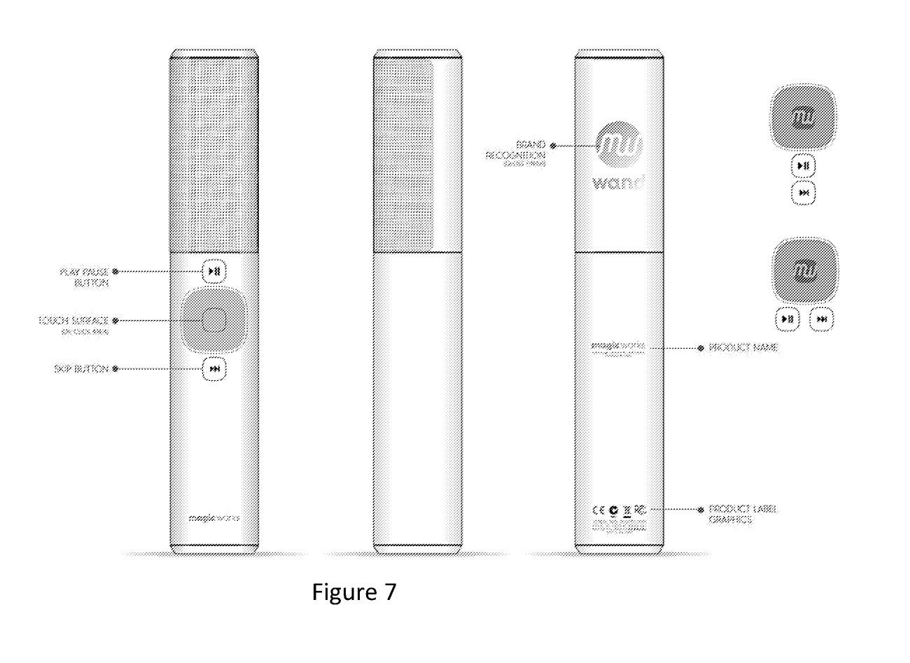

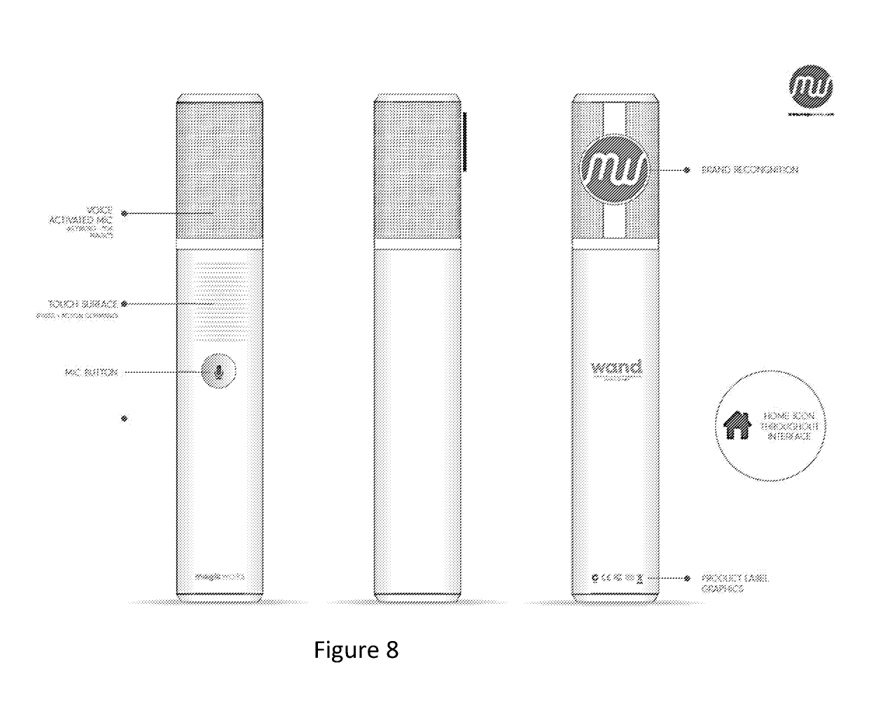

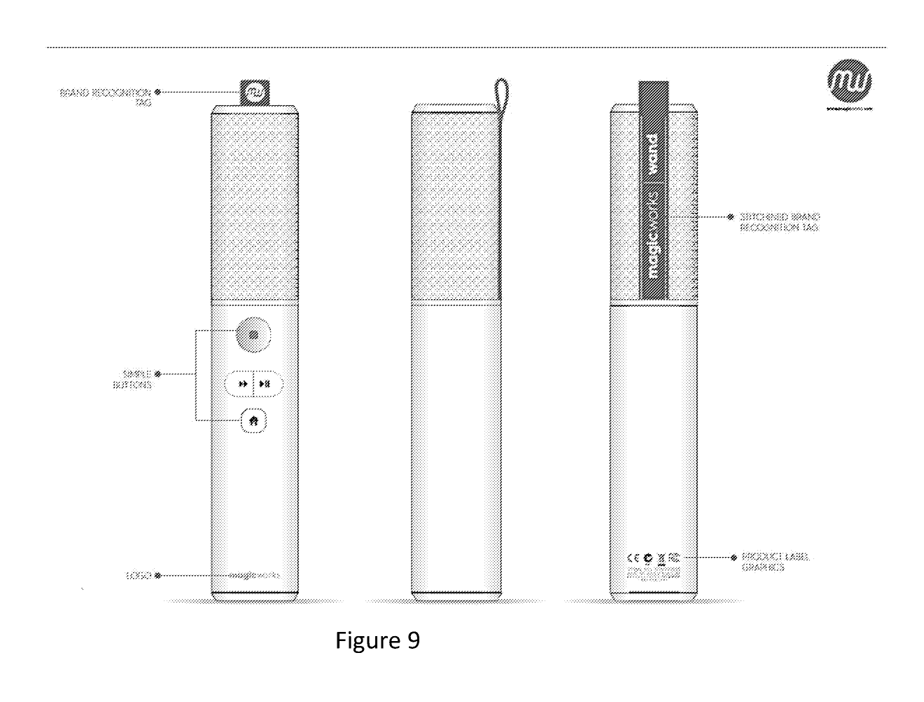

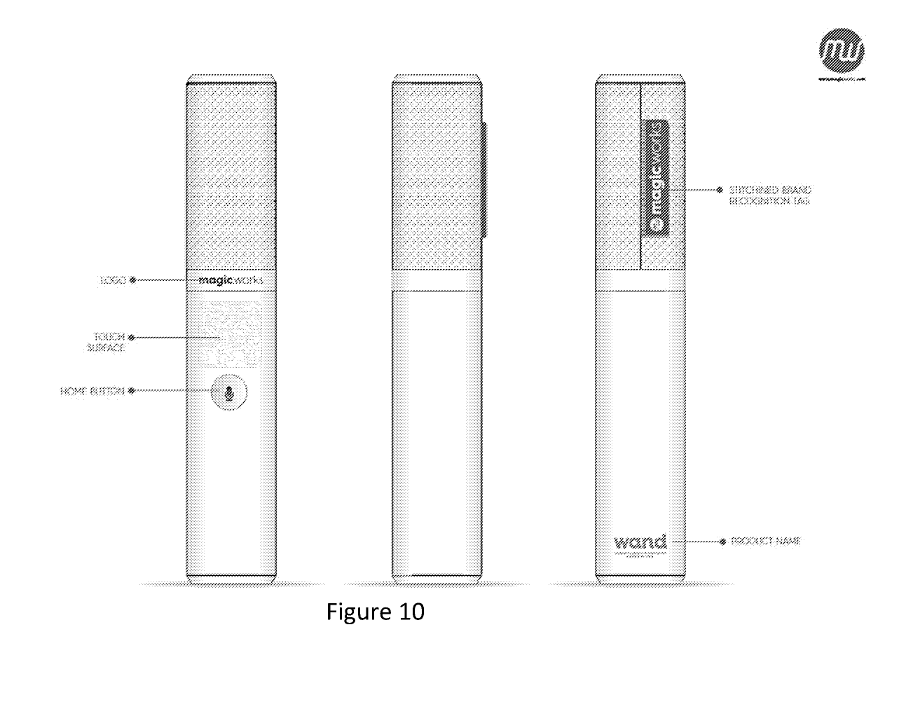

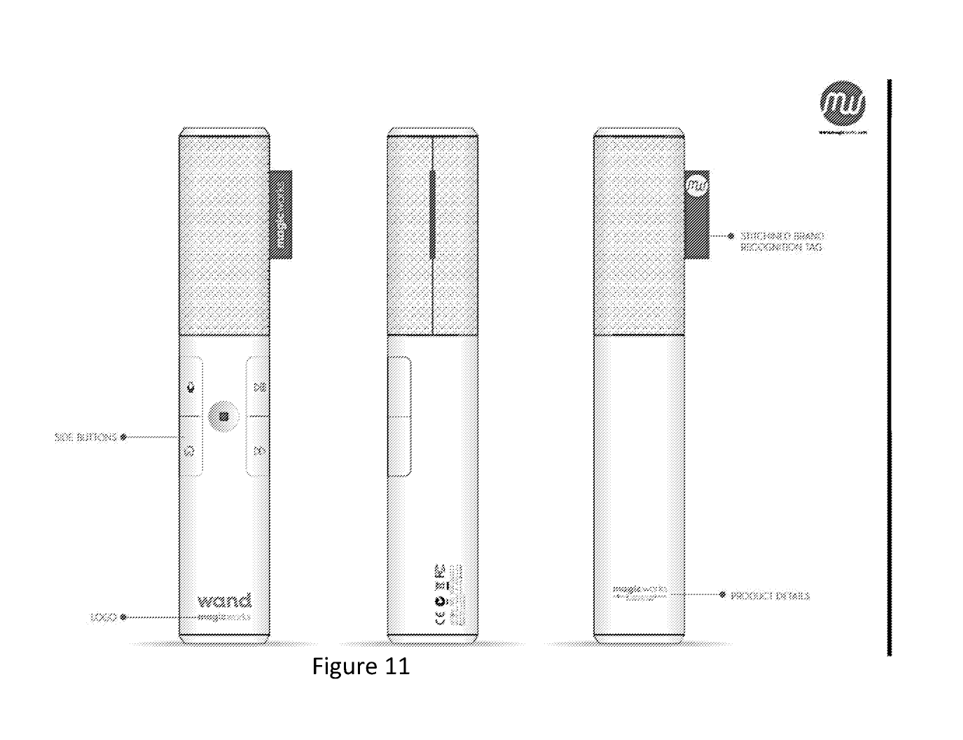

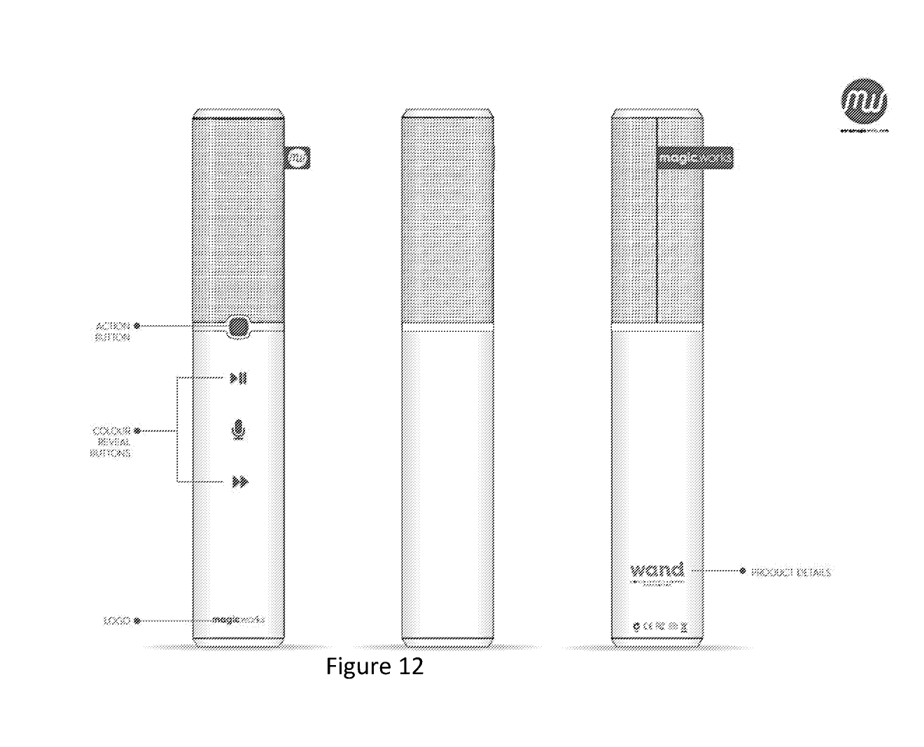

Various design studies for the controller are at FIGS. 2-12.

### The HDMI Stick

The HDMI stick is a HDMI 1.4 compliant Android single-board device that uses the consumer's WiFi to access the remote music delivery platform. It is built to operate “offline first”, and application caches are primed at the factory for an appliance-like first start experience. Key electronic components are:

Quad-core 28nm 1.4GHz ARM-A9.

1GB System RAM, 4GB Flash Storage.

Graphics 1080p, 720p, 32-bit RGB

Bluetooth 2.1 EDR, WiFi 802.11 b/g/n 2.4GHz

3.5 mm audio line-out.

Power: Micro USB, 5V, 1.0A.

Features include the following:

The stick must be robust to survive an 18-month product lifecycle.

The stick must have enough computing power for a smooth user experience (minimum 30 frames per second).

The stick must be able to smoothly play HD video (1080P) at full screen at 30 frames per second.

The stick must be able to handle large image, audio and video files in volatile memory.

The stick must be able to store and persist local data even after being turned off.

The stick must output audio and video using HDMI 1.4 or greater to the TV.

The stick must support Bluetooth 3.0 to connect to other devices to stream music.

The stick must be able to support hardware accelerated software (OpenGL, WebGL, CSS3D, CSS3 Transformations).

The stick must be able to support display resolutions of up to 1920 by 1080 pixels (1080p) and 1280 by 720 pixels (720p).

The stick must have an integrated Micro USB charge cable.

The stick must be a closed system appliance to the consumer, but the developer must have a method to program it.

The stick must have a USB power plug with the correct voltage and frequency designed to work in the destined country, or be powered through the TV over USB.

The stick must be able to connect to the Internet over a wired or wireless connection and using secure protocols.

The stick must run Android 4.4 (Kit Kat) and provide a mechanism to update to future versions of Android.

The stick must support simple connection to a WIFI network using WPS.

The stick must have a stable and consistent connection to the Internet over both wired or wireless connections.

The stick must be easily paired to the controller.

The stick must support secure streaming of audio content.

The stick must support secure streaming of video content.

The stick must support standard image types (PNG, JPG, GIF, BMP).

The stick must have a programmable LED to represent different states with different patterns, like power-on.

The stick must be able to enter and exit a low-powered standby mode.

The power plug must be able to simultaneously power the stick and controller; and come with the necessary USB cables.

The stick must be able to consume and interpret 3D data from the controller.

The stick must be able to play streamed CD quality audio.

The components on the stick must interoperate and function together without conflict to provide the best experience possible.

The stick could support sharing media between connected multimedia devices, for example using DLNA.

The stick could support dual band wireless.

The stick could support soft pairing controllers.

The stick could output audio in 5.1 (or 7.1) channels for surround sound

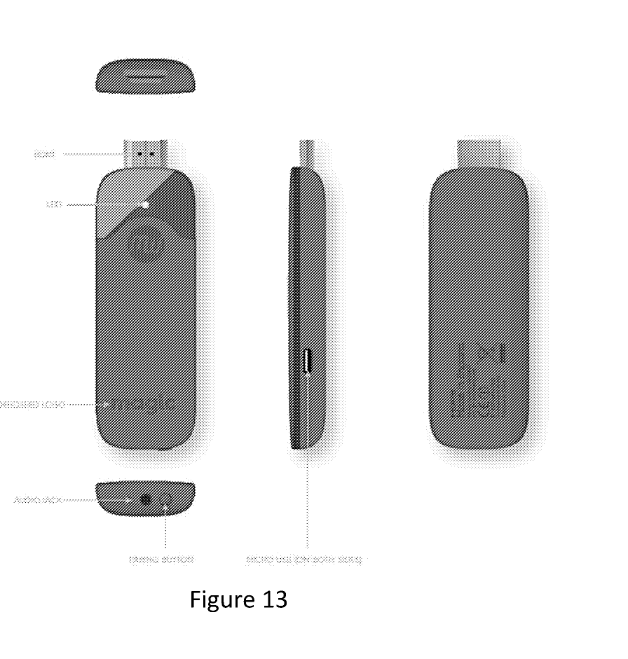

A design study for the stick is at FIG. 13.

### Client Application

The client application runs embedded on the TV HDMI stick, written in HTML 5 and based around AngularJS, a robust framework for dynamic web applications—supporting semantic extension of HTML and enabling succinct containment, assembly and testing of functionality. The app is built to maximise usage of the GPU on the TV stick for native-like performance, with the advantage of being portable to future products and platforms. The Android boot loader will be modified to load directly—with no impression of the underlying operating system. Back-end functionality is defined as a series of micro services accessing platform services via JSON/HTTP.

The server components are developed with couchDB and nodeJS or couch app javascript functions, and hosted on AWS & Cloudant. Micro-services are fronted on the client by off-line first javascript libraries—keeping the architecture as simple and testable as possible, while providing a clear route to running out-of-process and full cloud deployment in nodeJS where this benefits application performance.

We will now look at the user interface (UI) and the total user experience (UX).

The UX menu structure is designed to be simple and intuitively easy to understand.

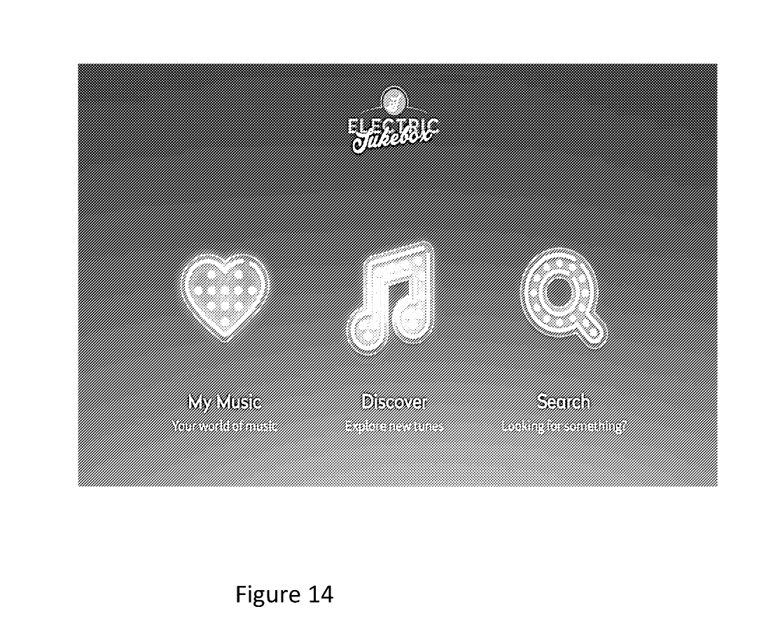

Music services typically feel like an Excel spreadsheet—a lean-forward laptop style experience. The UX we have in the TV-based implementation is completely different, offering a lean-back, ten-foot user interaction maximising use of large full screen imagery shown on the TV with elegant, considered typography. At the top level of the menu, , hierarchy is the home screen, as shown in FIG. 14. This includes just three user selectable icons: ‘My Music’, ‘Discover’ and ‘Search’.

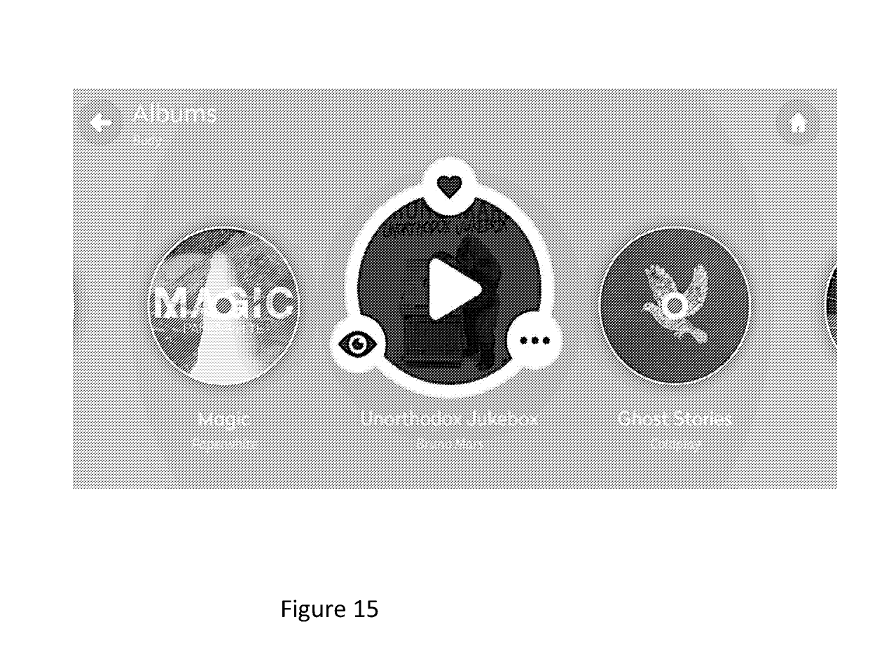

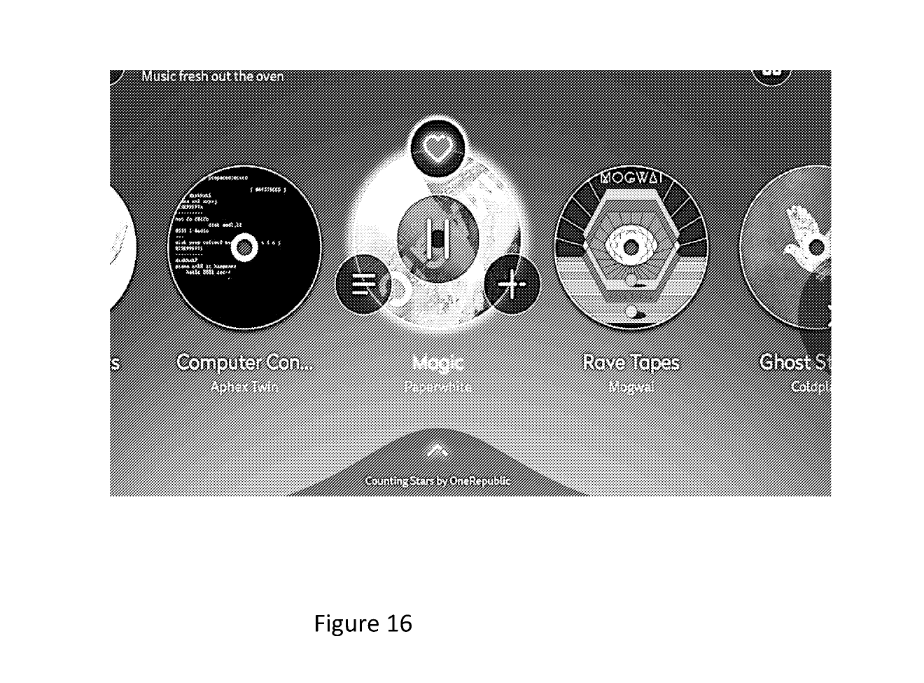

Selecting the My Music icon (e.g. using the motion sensitive remote controller to move an icon until it is over the ‘My Music’ icon and selecting the ‘action’ or ‘OK’ button on the controller) brings up a 1^{st} level screen that shows the user's personal playlist, arranged as an array or vinyl or CDs, as shown in FIG. 15. An alternative UX is shown in FIG. 16.

Each CD or vinyl record includes just 4 control icons: a central ‘play’ arrow, a ‘heart’ icon that adds the track to a favourites list and so makes it accessible from the ‘My Music’ icon (and can also link into social aspects of the service—for example, acting in the same way as a ‘Like’ icon in Facebook); a “+’ icon that adds the album or track to a playlist (which again makes it available from the ‘My Music’ icon) and an ‘info’ icon.

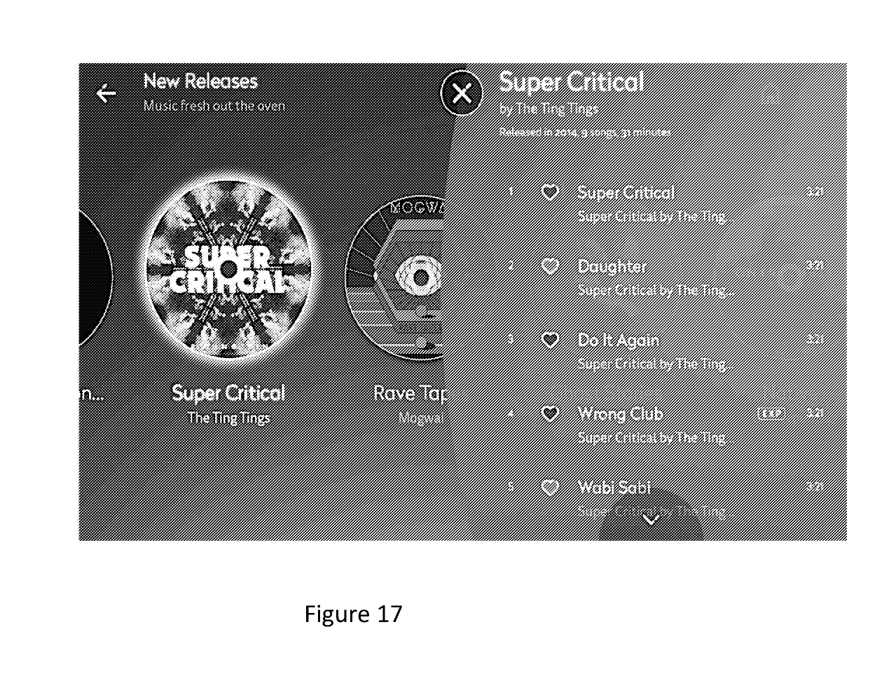

Selecting the ‘info’ icon causes a window or panel to be displayed with all the tracks on the selected album, as shown in FIG. 17.

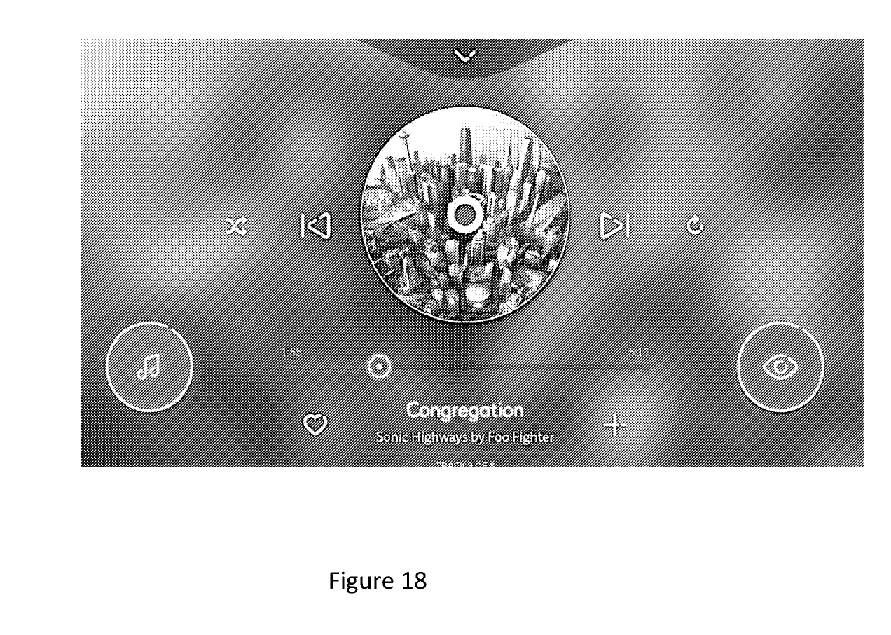

When a specific album or track is playing, the associated CD or vinyl is shown spinning around, together with self-explanatory control icons. This is the third and deepest level of the UX—specific to the actual music album or track being played, and is shown in FIG. 18.

The use or re-purposing of the large screen of a TV set as the UX allows the group of people watching the screen to see all the tracks and for the person with the controller to then move the cursor around until the right track is chosen—selecting the ‘action’ button on the controller then plays that track. It is possible also to queue up a sequence of tracks and/or albums.

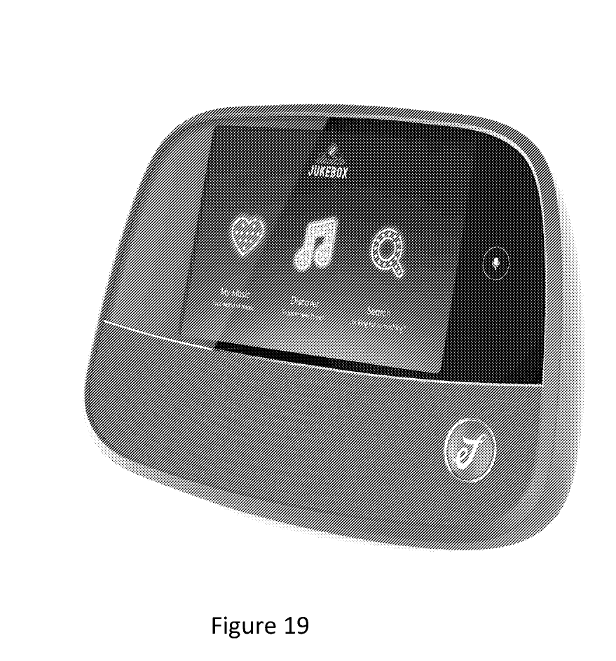

The second implementation is a self-contained small, speaker system with an Android embedded SOC and a touch sensitive screen, that will allow users to access a streaming music service via an Android app/Web Interface embedded in the system. The product is shown in FIG. 19 and includes a speaker and a touch sensitive screen to control the UX (similar to that used in the remote control based device that uses the TV as its playback resource), and has a rechargeable battery that enables the unit to operate for approximately 30 minutes—sufficient to enable it to carry on working as it is being moved from room to room, but not so long at it is classified as a portable device as far as the music content owners are concerned. A detailed product specification is at Appendix 2.

The unit will be able to be moved from room to room, but is not intended to be a portable device (portable devices typically need to be licensed for offline mode—i.e. download of media assets rather than streaming, and those license terms are generally significantly twice as costly than license terms for pure streaming with no download capability). The unit connects to the domestic Wi-Fi and from there to the remote music or media platform, just like the HDMI stick above. It can also be controlled using the same remote control, but can equally well be controlled using the touch screen panel.

It is to be understood that the above-referenced arrangements are only illustrative of the application for the principles of the present invention. Numerous modifications and alternative arrangements can be devised without departing from the spirit and scope of the present invention. While the present invention has been shown in the drawings and fully described above with particularity and detail in connection with what is presently deemed to be the most practical and preferred example(s) of the invention, it will be apparent to those of ordinary skill in the art that numerous modifications can be made without departing from the principles and concepts of the invention as set forth herein.

### Appendix 1

This section summaries 16 Core Concepts A-P. All concepts can be combined with any other concept or concepts; all ‘optional features’ can be combined with any concept or concepts and any other ‘optional feature’ or ‘optional features’.

### Concept A Works-out-of-the-Box Music+Licensed Device

Media playback system configured to automatically establish, a connection, via a wireless network, to an internet-based music platform delivering copyright-protected media assets and establishing access to some or all of those assets but without requiring in normal operation any prior user configuration, set-up, sign-up or other user identification for that media delivery platform;

the system automatically and uniquely identifying itself to the media delivery platform to enable that platform, or an access control component associated with the platform, to determine if the system is licensed to receive streaming media, irrespective of the user of the system.

Optional Features:

The system includes a portable remote control device that enables a user to select copyright-protected media, such as streaming music, from the media delivery platform.

The system re-purposes an existing media or sound reproduction system, such as a TV, hi-fi system or speakers, and uses that as its streaming media output source. The remote control can, where an existing TV is used as the media output source, be used to control a user interface displayed on the TV that enables an end-user to search for, select and playback media and receives that data and presents it via the HDMI interface to the TV for playback.

The system includes a self-contained device including a speaker, a power source, a user interface (such as a touch screen UI) and Wi-Fi or other LAN connectivity that enables a user to select copyright-protected media, such as streaming music, from the media delivery platform.

Concept B RC with Karaoke Mode

A remote control device for a music playback system, in which the remote control device includes a microphone and is voice-controlled, so that a user can select a specific music track or genre by speaking its name to the remote control device to initiate streaming from an internet-based music delivery platform and the system transmits sounds received at the microphone to an audio playback device, such as a television set, for the speakers in or connected playback device to reproduce, to for example enable a ‘karaoke’ mode.

Optional Features:

The system re-purposes an existing media or sound reproduction system, such as a TV, hi-fi system or speakers, and uses that as its streaming media output source.

Multiple pairing is possible—i.e. to pair several remote controls with the same media or sound reproduction system so that several people can join in the karaoke session, each using their own paired, remote control as a microphone.

### Concept C UX—Spinning CDs

A method of controlling functions in an application that enables music tracks to be streamed from a database of music tracks from an internet-based music delivery platform, in which menu items are displayed on a screen, and in which:

a music track or album is graphically represented as a CD or vinyl single or album that spins whilst it is playing.

Optional Features:

If search results have multiple different albums, or whenever you need to show multiple albums, then we show a stack of CDs

Menu items are selected using a remote control with motion or gesture detection Menu items are selected from a touch screen.

The method may be implemented using a system that includes a portable remote control device that enables a user to select copyright-protected media, such as streaming music, from the media delivery platform and the screen is the screen of a TV that is controlled by the remote control. The system re-purposes an existing media or sound reproduction system, such as a TV, hi-fi system or speakers, and uses that as its streaming media output source.

The method may be implemented using a system that includes a self-contained device including a speaker, a power source, a user interface with a touch screen UI and Wi-Fi or other LAN connectivity that enables a user to select copyright-protected media, such as streaming music, from the media delivery platform; and the CD or vinyl is shown on the touch screen of the self-contained device.

### Concept D Works-out-of-the-Box Music+Unique Device ID

Media playback system configured to automatically establish, a connection, via a wireless network, to an internet-based music platform delivering copyright-protected media assets and establishing access to some or all of those assets but without requiring in normal operation any prior user configuration, set-up, sign-up or other user identification for that media delivery platform;

the system including a device that stores and automatically sends a unique ID, e.g. a mac address, to the internet-based media platform when first used in order to unlock or to enable full access to the music on the media delivery platform, without any prior user configuration, set-up, sign-up or other user identification for that platform.

Optional Features:

The ID is used each time the device is used to validate that time of use has not expired. The unique ID is a copyright access ID.

The unique ID can allow content to be streamed from any other device (e.g. Chromecast, Sonos).

The device is a small, portable device that plugs into the HDMI port of a TV.

The system re-purposes an existing media or sound reproduction system, such as a TV, hi-fi system or speakers, and uses that as its streaming media output source.

The system includes a portable remote control device that enables a user to select copyright-protected media, such as streaming music, from the media delivery platform.

The device is a self-contained device including a speaker, a power source, a user interface and Wi-Fi or other LAN connectivity that enables a user to select copyright-protected media, such as streaming music, from the media delivery platform.

### Concept E Works-out-of-the-Box Music+Unique Device ID+Unique Customer ID

Media playback system configured to automatically establish, a connection, via a wireless network, to an internet-based music platform delivering copyright-protected media assets and establishing access to some or all of those assets but without requiring in normal operation any prior user configuration, set-up, sign-up or other user identification for that media delivery platform;

the system including a device that automatically sends a unique device ID, e.g. a mac address, to the internet-based media delivery platform and that unique device ID is then associated with a customer ID that is unique for a specific customer, that unique customer ID then being associated with data for that customer, such as profiles, playlists, listening behavior.

Optional Features:

That customer ID can be used to associate that customer data with a different unique device ID, so that if the device that sent the original unique device ID is lost or damaged, then a replacement device can be set-up for that customer and that customer can use their stored profiles, playlists or listening behaviour.

### Concept F Works-out-of-the-Box Music+Remote Control

Media playback system configured to automatically establish, a connection, via a wireless network, to an internet-based media platform delivering copyright-protected media assets and establishing access to some or all of those assets but without requiring in normal operation any prior user configuration, set-up, sign-up or other user identification for that music delivery platform;

the system including a portable remote control device that enables a user to select copyright-protected media, such as streaming music, from the media delivery platform.

Optional Features:

The system re-purposes an existing media or sound reproduction system, such as a TV, hi-fi system or speakers, and uses that as its streaming media output source.

### Concept G Works-out-of-the-Box Music+Remote Control/Stick

Media playback system configured to automatically establish, a connection, via a wireless network, to an internet-based music platform delivering copyright-protected media assets and establishing access to some or all of those assets but without requiring in normal operation any prior user configuration, set-up, sign-up or other user identification for that media -delivery platform;

the system including a remote control device and a unit that plugs into an interface of an audio playback device, such as the HDMI port of a television set, in which both the remote control device and the unit each store a different, unique device ID.

Optional Features:

The remote control device and unit are used at a first primary location by a user, and user data, such as profiles, playlists, listening behavior, is accessible on the audio playback device.

The remote control device can be used at a different location where there is a different audio playback device with a different unit plugged into its interface, and that same user data, such as profiles, playlists, listening behavior, is then accessible on the different audio playback device.

### Concept H Psycho-Acoustic/Familiarity Driven Shuffle

A method of automatically selecting music tracks for streaming from a playlist or a database of music tracks in which each track is labeled or meta-tagged with data defining the likely familiarity of a music track to a defined target audience, and tracks are then automatically selected from the playlist or database for streaming using an algorithm that selects tracks based on their likely familiarity.

Optional Features:

Music track selection is a shuffle of the existing tracks in a playlist

Familiarity is defined in terms of three categories (where category ‘1’ is a current hit track, ‘2’ is familiar to many but not currently a hit and ‘3’ is an unusual or much less well known track).

Time based shuffle occurs of the tracks in different categories, for example, a category 1 track could be played regularly every n tracks

### Concept I UX—Tunnels

A method of controlling functions in an application that enables media tracks to be streamed from a database of media tracks from an internet-based media delivery platform, in which menu items are displayed on a screen and are selected using a remote control with motion or gesture detection, and in which:
(a) progressing between levels in the menu hierarchy is represented by a graphical image of passing through a tunnel, in order to make level progression more visually prominent and to maintain context for the user when viewing at distances greater than normal smartphone viewing distances, of for example 30 cm.

Optional Features:

The graphical image is of forward tunneling when going deeper, and reverse tunnelling when coming back up the menu hierarchy

### Concept J Dedicated RC

A remote control device for a music playback system, in which the remote control device is dedicated to and optimised for music search and control and includes a microphone and is voice-controlled, and also motion sensor(s) and is also gesture controlled and also includes a touch panel or surface and is also touch controlled.

### Concept K RC Pre-Paired to HDMI Stick

Media playback system configured to automatically establish, a connection, via a wireless network, to an internet-based music platform delivering copyright-protected media assets and establishing access to some or all of those assets but without requiring in normal operation any prior user configuration, set-up, sign-up or other user identification for that media -delivery platform;

the system including a remote control device and a unit that plugs into an interface of an audio playback device, such as the HDMI port of a television set, the remote control device communicating with the unit over a wireless connection and being factory-paired, or otherwise pre-paired with the unit, so that no user pairing is necessary on initial set-up.

Optional Features:

Wireless connection is RF and not IrDa

Concept L Works-out-of-the-Box Music+RC with Motion Control

A portable remote control device that controls, using motion-based inputs, an internet-based media delivery platform to deliver streaming media services to an audio playback device, such as a television set, and in which the audio playback device is automatically connected to the internet-based media delivery platform via a wireless network and, once connected, the remote control device enables the user to search for, select and initiate streaming of media, using motion-based inputs, but without requiring in normal use any prior user configuration, set-up or sign-up or other user identification for that music delivery platform.

Concept M RC with Only 4 Buttons

A remote control device for a music playback system, in which the remote control device includes a microphone and is voice-controlled, so that a user can select a specific music track or genre by speaking its name to the remote control device;

and the remote control device has only four user interaction control buttons: (1) an action button; (2) a play or resume button; (3) a back button and (4) a microphone activation button.

Optional Features:

Press and hold on the ‘action’ button allows scrolling of page back and forwards

Press and hold on the ‘back’ button takes you to home

Cursor movement and gestures allow panning and scrolling of content within the page

Remote control device includes an accelerometer and gyro

Concept N RC with Removable Fabric Cover

A remote control device for a music playback system, in which the remote control device include a user-removable cover made at least in part of fabric material.

Optional Features:

The fabric material is formed over one end of the device so that the device appears to be a microphone.

The user-removable cover is just the fabric material portion of the device.

The user-removable cover is a cover for the entire device.

### Concept O UX—Lava

A method of controlling functions in an application that enables music tracks to be streamed from a database of music tracks from an internet-based music delivery platform, in which menu items are displayed on a television screen and are selected using a remote control with motion or gesture detection, and in which:

(a) selectable menu items are shown arranged on or in a sinuous or wave-like form;

(b) the sinuous or wave-like form rises up at the location of a menu item that the user is pointing to or selecting with the remote control, to make that menu item more visually prominent when viewing at normal television viewing distances.

Concept P RC with LED

A remote control device for a music playback system, in which the remote control device includes a light source such as a LED that is set to pulse with light from the time of factory manufacture.

### Other Features

Each of the features below can be combined with any one or more Concepts above (or optional features associated with each concept) above and any one or more other optional features.
the system re-purposes an existing media or sound reproduction system and uses that as its streaming media output source.
the system is external to an audio playback device, such as a television set, but uses the speakers and the display screen of, or connected to, the audio playback device, to reproduce the music
the system includes a remote control device and a unit or ‘stick’ that plugs into the HDMI port of a television set, the remote control device communicating with the unit over a wireless connection.
the HDMI stick includes a line out socket
the system includes a self-contained device including a speaker, a power source, a user interface (such as a touch screen user interface) and Wi-Fi or other LAN connectivity that enables a user to select copyright-protected media, such as streaming music, from the media delivery platform.
the remote control device is hard-paired or pre-pared with the HDMI unit, so that no manual user pairing is necessary on initial set-up
the remote control device is DECT linked to the HDMI unit to avoid the need to hard-pair them together
the remote control device uses motion sensors to detect a user's control inputs
the system uses the speakers of or connected to the television set to reproduce the media
the system uses the display of the television set to provide a graphical user interface that enables the user to control the system
the remote control device is a dedicated remote control device, namely one whose sole or primary purpose is to operate as a remote control for a wireless-connected device, such as a television or hi-fi system
the remote control device is a smartphone running a remote control companion app
the remote control has no power button and instead wakes up from sleep if movement occurs; goes into deep hibernation if there is no activity for e.g. 20 minutes
the system automatically sends a unique ID e.g. mac address, to the internet-based media delivery platform when first used in order to unlock or to enable full access to the media on the media delivery platform, without any prior user configuration, set-up or sign-up
access to some or all of those assets on the media delivery platform is, unlimited and user-defined
full access to the media on the media delivery platform is for a defined time period
full access to the media on the media delivery platform is contingent on adverts being injected or accompanying the streaming media (e.g. music), for example with the adverts being displayed on the screen of a television set whilst the streaming music is played from the speakers of the television set
the remote control device includes a microphone and is voice-controlled, so that a user can select a specific media item by speaking its name to the remote control device
the system transmits sounds received at the microphone to the television set, for the speakers in or connected to the television set to reproduce, to for example enable karaoke mode.
the unit that plugs into the HDMI port generates a user interface for the media playback system on the screen of the television set
the playback control screen of the user interface is automatically displayed on the screen if the remote control is moved within a defined period of inactivity (e.g. 20 minutes, but configurable).
the system learns a user's music preferences
the system learns a user's music preferences because after a number of plays a track of album is automatically promoted into being a favourite, and if a track is skipped a number of times is automatically skipped thenceforth.
the system learns a user's music preferences as a function of time of day ands/or day of the week and enables the user to make selections on this basis, and these time periods may be used as the basis of further filtering
if the remote control is picked up or moved then the system displays the “transport” controls (play/pause; skip forwards and backwards)
the internet-based music delivery platform is protected by a paywall for users not using the music system defined above
the music delivery platform includes several million music tracks
the user has to input its password to access the local Wi-Fi
the system streams film and other media assets, as well as music
if the user points the remote control device to e.g. a radio set or TV etc. playing a song and a remote music recognition service is accessed by the platform to recognise the track, then the platform provides that track for streaming
Wireless network is established using a Wi-Fi router or other internet-connected router
Wireless network is 3G or 4G or LTE

### UX Features

the system generates and presents a user interface with a home screen that includes three icons for ‘My Music’, ‘Discover’ and ‘Search’ or equivalent functionality.
The user interface includes a first level UI which is a skeuomorphic representation of physical recording media, such as CDs, vinyl, album covers etc.
The skeuomorphic representation of physical media are arranged in an array and the user can scroll or navigate through the array.
When a user selects a particular CD or vinyl to play, then the representation of the CD or vinyl will start to spin around in a skeuomorphic representation; this may be in a second level down in the UX hierarchy.
The ‘Discover’ mode when selected causes a skeuomorphic representation of physical recording media, such as CDs, vinyl to be displayed, each associated with a different curator or genre or channel or other source.
The ‘Search’ mode when selected causes an on-screen keyboard to be shown, together with a microphone icon; selecting the microphone icon activates a voice recognition system, allowing the user to simply speak the name of the artist, album genre, curator etc.
When a specific artist is chosen, then a skeuomorphic representation of physical recording media, such as CDs, vinyl, album covers of that artist is shown in a n array that the user can readily scroll or navigate through.
The UX has three primary levels of depth for simplicity and ease of user comprehension: (1) the home screen, with the three key functions of ‘My Music’, ‘Discover’ and ‘Search’ or equivalent functionality; (2) the array of CDs or vinyl associated with the function selected at the home screen level: (3) a screen showing the currently playing album or track.
user tagging of content is possible, e.g. hashtags.
user defined collections of one or more of the following: artists, albums and tracks, radio stations and pod casts, are formed as searchable objects

### RC Features

has only four buttons: (1) Action; (2) Back; (3) Play/Resume; (4) microphone activation
replaceable fabric cover to allow different fabric designs and so that RC looks more like a microphone
twist control: twisting the RC around its long axis is a control input for navigating through a GUI shown in a screen, e.g. a TV display, the GUI depicting a graphical image of passing through a tunnel, in order to make level progression more visually prominent when viewing at normal television viewing distances

### Appendix 2

Product Requirements

| Component | Configuration | Notes |
|---|---|---|
| SoC Platform | Rockchip | |
| CPU | Rockchip RK3188 ARM A9 | |
| | Quad-Core 1.4 GHz | |
| Cores | 2 | |
| RAM | 1 GB DDR3 | |
| Storage | 4 GB Flash NAND | To store local data |
| HDMI | HDMI 1.4 (with Consumer | CEC to control TV input source and |
| | Electronics Control) | other features like ARC and HEC |
| HDMI Socket | 19 pin socket | |
| HDMI Extension | Yes | |
| Cable | | |
| Bluetooth | Bluetooth 2.1 EDR | Connect to external speakers, can be |
| | | 2.1+EDR, 3.0 or 4.0 |
| GPU | ARM Mali-400 MP4 | |
| Graphics Display | 1920 by 1080 (1080p), 1280 by | 1080p to be handled natively |
| Resolution | 720 (720p) | |
| Colours | 32-bit RGB, 16.7 million | |
| | colours with transparency | |
| Power Method | USB (integrated, non- | Powered through the TV USB port or |
| | detachable 12-inch cable) | can be connected to a USB extension |
| | | cable that is plugged into the power |
| | | adapter. |
| Network: WIFI | 802.11 b/g/n (2.4 GHz) | Single band or dual band |
| Network: | 10/100 Base-T (external | Wired connection for those who don't |
| Ethernet | Micro-USB port to connect | have WI-FI, or poor WI-FI signal. |
| | RJ-45) | Additional connector on Stick Board |
| WIFI Encryption | WEP, WPA, WPA2 | WPS also desirable |
| External WIFI | Yes (integrated into external | Sleek design as external antennae are |
| antenna | casing). | prone to breaking and to improve |
| | | wireless signal quality. |
| Wireless 2.4 Ghz | Yes (paired) | Embedded in the device and paired to |
| receiver | | the controller. Need to be changed by |
| | | Key combination by end user. |
| Sound | Stereo | 2 channel stereo, CD quality audio |
| LED feedback | Yes | Power indicator |
| with | | |
| programmable | | |
| patterns | | |
| SD Card | No | Closed system to the consumer, only |
| Expansion Slot | | developers can access the device to |
| | | program it |
| Micro USB Ports | 1 (USB 2.0) | External port is used to connect to an |
| | | RJ-45 Micro USB adapter; is used by |
| | | developers to program the device by |
| | | connecting a Micro USB cable |
| Operating System | Android 4.4.x (Kit Kat) | Closed system to the consumer, only |
| | | developers can access the device to |
| | | program it. Improvements include |
| | | better support for low powered devices, |
| | | better native web view and browser |
| | | debugging tools |

Media Formats

| Type | Codec | Mime Type | Details | Containers |
|---|---|---|---|---|
| Audio | AAC-LC | audio/mp4a-latm | Up to 96 kHz, 6 | 3GPP (.3gp) |
| | | | channels, 16-bit and 24- | |
| | | | bit. | |
| | | | | MPEG-4 |
| | | | | (.mp4) |
| | | | | M4P (.m4p) |
| | | | | AAC (.aac) |
| | HE-AACv1 | audio/mp4a-latm | Up to 96 kHz, 6 | 3GPP (.3gp) |
| | (AAC+) | | channels, 16-bit and 24- | |
| | | | bit. | |
| | | | | MPEG-4 |
| | | | | (.mp4) |
| | | | | M4P (.m4p) |
| | | | | AAC (.aac) |
| | HE-AACv2 | audio/mp4a-latm | Up to 96 kHz, 6 | 3GPP (.3gp) |
| | (enhanced | | channels, 16-bit and 24- | |
| | AAC+) | | bit. | |
| | | | | MPEG-4 |
| | | | | (.mp4) |
| | | | | M4P (.m4p) |
| | | | | AAC (.aac) |
| | FLAC | audio/flac | Up to 48 kHz, 2 | FLAC (.flac) |
| | | | channels, 16-bit and 24- | |
| | | | bit (no dither for 24 bit). | |
| | MP3 | audio/mp3 | Up to 48 kHz, 2 | MP3 (.mp3) |
| | | | channels in DSP (16-bit | |
| | | | and 24-bit) and software | |
| | | | (16-bit). | |
| | Vorbis | audio/vorbis | | Ogg (.ogg) |
| Video | H.263 | video/3gp | Hardware accelerated | 3GPP (.3gp) |
| | | | up to WVGA | |
| | | | (800×480), 30fps, 6 Mbps, | |
| | | | Profile 0 Level | |
| | | | 70. | |
| | | | | MPEG-4 |
| | | | | (.mp4) |
| | H.264 | video/avc | Up to 1080p, 30 fps, 20 Mbps, | 3GPP (.3gp) |
| | | | High Profile up | |
| | | | to Level 4. | |
| | | | | MPEG-4 |
| | | | | (.mp4) |
| | | | | MPEG-TS |
| | | | | (.ts) |
| | MPEG-4 | video/mp4v-es | Up to 1080p, 30 fps, 20 Mbps, | 3GPP (.3gp) |
| | | | Advanced Simple | |
| | | | Profile Level 5. | |
| | VP8 | video/x- | | WebM |
| | | vnd.on2.vp8 | | (.webm) |
| Image | JPEG | N/A | Base and progressive. | JPEG (.jpg) |
| | GIF | N/A | | GIF (.gif) |
| | PNG | N/A | | PNG (.png) |
| | BMP | N/A | | BMP (.bmp) |

1. A media playback system configured to automatically establish a connection, via a wireless network, to an internet-based media platform delivering copyright-protected media assets and establishing access to some or ail of those assets but without requiring in normal operation any prior user configuration, set-up, sign-up or other user identification for that media delivery platform;
the system automatically and uniquely identifying itself to the media delivery platform to enable that platform, or an access control component associated with the platform, to determine if the system is licensed to receive streaming media, irrespective of the user of the system.

2. The media playback system, of claim 1, the system including a portable remote control device that enables a user to select copyright-protected media, such as streaming media, from the media delivery platform.

3. The media playback system of claim 2 in which the remote control is used to control a user interface displayed on a media output source that enables an end-user to search for, select and playback media.

4. The media playback system of claim 3 in which the media output source is a TV that has been re-purposed to serve as a streaming media output.

5. The media playback system of claim 1, (i) in which the system includes a unit or ‘stick’ that plugs into an interface port of the media output source and that generates the user-interface and receives and processes control inputs from the remote control and sends data requesting media to the media delivery platform and receives that data and presents it via the interface to the media output source for playback, or (ii) in which the system includes a unit or ‘stick’ that plugs into an interface port of the media output source and that generates the user-interface and receives and processes control inputs from the remote control and sends data requesting media to the media delivery platform and receives that data and presents it via the interface to the media output source for playback, and in which the interface is an HDMI interface.

6. (canceled)

7. The media playback system of claim 1 in which the system includes a self-contained device including a speaker, a power source, a user interface and Wi-Fi or other LAN connectivity that enables a user to select copyright-protected media, such as streaming music, from the media delivery platform.

8. The media playback system of claim 1, where the system connects with an electronic unit and then allows media content to be streamed from that electronic unit.

9. The media playback system of claim 1 in which the system includes a device that stores and automatically sends a unique ID to the internet-based media platform when first used in order to unlock or to enable full access to the media on the media delivery platform, without any prior user configuration, set-up, sign-up or other user identification for that platform.

10. The media playback system of claim 9, (i) in which the unique ID is a mac address, or (ii) where the unique ID is usable each time the device is used to validate that a predefined time period for which full access is enabled has not expired or is still current, or (iii) where the unique ID is a copyright access ID.

11-12. (canceled)

13. The media playback system of claim 9, (i) where the unique device ID is associated with a customer ID that is unique for a specific customer, that unique customer ID then being associated with data for that customer, such as profiles, playlists, listening behavior, or (ii) where the unique device ID is associated with a customer IP that is unique for a specific customer, that unique customer ID then being associated with data for that customer, such as profiles, playlists, listening behaviour, and wherein the customer ID may be used to associate that customer data with a different unique device ID, so that if the device that sent the original unique device ID is lost or damaged, then a replacement device can be set-up for that customer and that customer can use their stored profiles, playlist or listening behavior.

14. (canceled)

15. The media playback system of claim 3, (i) in which a user interface home screen is automatically displayed if the remote control is moved within a defined period of inactivity (e.g. 20 minutes, configurable), or (ii) where the remote control device and unit is usable at a first primary location by a user, and user data, such as profiles, playlists, listening behaviour, is accessible on the audio playback device, or (iii) where the remote control device and unit is usable at a first primary location by a user, and user data, such as profiles, playlists, listening behaviour, is accessible on the audio playback device, and where the remote control device is usable at a different location where there is a different audio playback device with a different unit plugged into its interface, and that same user data, such as profiles, playlists, listening behaviour, is then accessible on a different audio playback device, or (iv) in which the portable remote control device controls, using motion based inputs, the internet-based media delivery platform to deliver streaming media services to an audio playback device, such as a television set, and in which the audio playback device is automatically connected directly or indirectly to the internet-based media delivery platform via wireless network and, once connected, the remote control device enables the user to search for, select and initiate streaming of media, using motion based inputs, but without requiring in normal use any prior user configuration, set-up or sign-up or other user identification for the media delivery platform.

16-18. (canceled)

19. The media playback system of claim 1 that generates or provides a user interface that includes a skeuomorphic representation of physical recording media, such as CDs, vinyl, album covers.

20. The media playback system of claim 19 in which the skeuomorphic representation of physical media are arranged in an array and the user can scroll or navigate through the array and, when a user selects a particular CD or vinyl to play, then the representation of the CD or vinyl will start to spin around in a skeuomorphic representation.

21. The media playback system of claim 1 that generates or provides a user interface with three primary levels of increasing depth for simplicity and ease of user comprehension: (1) the home screen, with the three key functions of ‘My Music’, ‘Discover’ and ‘Search’ or equivalent functionality; (2) an array of CDs or vinyl or album covers associated with the function selected at the home screen level: (3) a screen showing or identifying the currently playing album or track.

22. The media playback system of claim 21, (i) in which the ‘Discover’ mode when selected causes a skeuomorphic representation of physical recording media, such as CDs, vinyl or album covers to be displayed, each associated with a different curator or genre or channel or other source, or (ii) in which the ‘Search’ mode when selected causes an on-screen keyboard to be shown, together with a microphone icon; electing the microphone icon activates a voice recognition system, allowing the user to simply speak the name of artist, or album or genre or curator, or (iii) in which, when a specific artist is chosen, then a skeuomorphic representation of physical recording media, such as CDs, vinyl, album covers of that the artist is shown in an array that the user can scroll or navigate through.

23-24. (canceled)

25. The media playback system of claim 1, configured to perform a method of automatically selecting media tracks for streaming from a playlist or a database of media tracks in which each track is labelled or meta-tagged with data defining the likely familiarity of a media track to a defined target audience, and tracks are then automatically selected from the playlist or database for streaming using an algorithm that selects tracks based on their likely familiarity.

26. The media playback system of claim 25, wherein familiarity is defined in terms of three categories, where category ‘1’ is a current hit track, ‘2’ is familiar to many but not currently a hit and ‘3’ is an unusual or much less well known track.

27. The media playback system of claim 26, wherein a time based shuffle may occur for the tracks in different categories, for example, a category 1 track could be played regularly every n tracks.

28. The media playback system of claim 1, in which full access to the media on the media delivery platform is for a defined time period and the first use is recorded at a remote server.

29. The media playback system of claim 1, in which the system includes a microphone that provides speech or sound output to the media output source to enable karaoke mode.

30. The media playback system of claim 29 where a remote control includes the microphone.

31. The media playback system of claim 1, configured to learn a user's media preferences, or connectable to an internet-based media delivery platform which is protected by a paywall for users not using the media system defined above.

32. (canceled)

33. A method of enabling a media playback system to automatically establish a connection, via a wireless network, to an internet-based media platform delivering copyright-protected media assets and establishing access to some or all of those assets but without requiring in normal operation any prior user configuration, set-up, sign-up or other user identification for that media delivery platform; the method including steps of
(i) the system automatically and uniquely identifying itself to the media delivery platform with a unique identifier;
(ii) the platform, or an access control component associated with the platform, determining, using the unique identifier, if the system is licensed to receive streaming media, irrespective of the user of the system;
(iii) if the system is licensed, then providing access to search and stream some or all of the media assets.

34. The method of claim 33 (i) in which the unique identifier is a mac address, or (ii) including the step of storing the date of first use of the system or its access to the media delivery platform and permitting continued access to search and stream some or all of the media assets for a predefined time period, or (iii) including the step of using a portable remote control device to enable a user to select copyright-protected media, such as steaming media, from the media delivery platform, or (iv) including the step of using a portable remote control device to enable a user to select copyright-protected media, such as streaming media, from the media delivery platform, and including the step of using the remote control to control a user interface displayed on a media output source that enables an end-user to starch for, select and playback media, or (v) including the step of using a portable remote control device to enable a user to select copyright-protected media, such as streaming media, from the media delivery platform, and including the step of using the remote control to control a user interface displayed on a media output source that enables an end-user to search for, select and playback media, and including the step of using a TV that has been re-purposed to serve as a streaming media output, or (vi) including the step of using a portable remote control device to enable a user to select copyright-protected media, such as streaming media, form the media delivery platform, and including the step of using the remote control to control a user interface displayed on a media output source that enables an end-user to search for, select and playback media, and including the step of using a TV that has been re-purposed to serve as a streaming media output, including the step of plugging a unit or ‘stick’ into an interface port of the media output source and then using the stick to generate the user-interface and receive and process control inputs from the remote control and send data requesting media to the media delivery platform and receive that data and present it via the interface to the media output source for playback.

35-39. (canceled)
